(19) United States
(12) Patent Application Publication
(10) Pub. No.: US 2009/0016089 A1
(43) Pub. Date: Jan. 15, 2009

(54) Electromechanical power transfer system with even phase number dynamoelectric machine and three level inverter

(76) Inventor: Vietson M. Nguyen, Rockford, IL (US)

Correspondence Address: STEPHEN GEORGE MICAN, Post Office Box 803338, #8973, Chicago, IL, 60680-3338, US

(21) Appl. No.: 11/825,818

(22) Filed: Jul. 9, 2007

(51) Int. Cl. H02M 7/06; H02M 7/537

(52) U.S. Cl. 363/125; 363/123; 363/131

(57) ABSTRACT

An electromechanical power transfer system that converts direct current (DC) electrical power to variable mechanical power, comprises: a source of DC that has a neutral ground, a positive potential output with a level of electrical potential that is positive relative to the neutral ground and a negative potential output with a level of electrical potential that is negative relative to the neutral ground; a multiphase alternating current (AC) dynamoelectric machine with an even number of phases; and a neutral point clamped (NPC) inverter system that receives electrical power from the positive and negative potential outputs the DC source to generate multiphase AC power for the dynamoelectric machine with the same number of even phases that exhibits no common mode potential/noise.

### FIELD OF THE INVENTION

The invention relates to electromechanical power transfer systems for dynamoelectric machines, and more particularly to electromechanical power transfer systems, that employ pulse width modulated (PWM) inverters for control of a dynamoelectric machine.

### BACKGROUND OF THE INVENTION

In the last few decades, industrial and commercial markets for motor drives that control dynamoelectric machines have concentrated heavily on the most popular three-leg six-switch inverters for three-phase machines. With those “simple” inverters, one of the troubles the motor drive manufacturers have faced is the failure of bearing systems in such dynamoelectric machines due mainly to sparked leakage currents created by common-mode very high frequency electromagnetic interference (EMI) electrical potentials in stator windings of the machines. These potentials are due to the switching operation of inverter power devices in the three-leg six-switch inverters, such as transistors, insulated gate bipolar transistors (IGBTs), metal oxide field effect transistors (MOSFETs) and power diodes.

The creation of common-mode potential occurs when an inverter power device for one of the three phases turns on and connects that phase to one side of a direct current (DC) bus whilst one or two other phases connect to the other side of the DC bus. As result, the potential at the middle or centre point of the three-phase system freely fluctuates within a wide range of levels and frequencies, which in turn will flow to ground via coupling impedance paths that are often due to stray and leakage capacitances.

### SUMMARY OF THE INVENTION

The invention generally comprises an electromechanical power transfer system that converts direct current (DC) electrical power to variable mechanical power, comprising: a source of DC that has a neutral ground, a positive potential output with a level of electrical potential that is positive relative to the neutral ground and a negative potential output with a level of electrical potential that is negative relative to the neutral ground; a multiphase alternating current (AC) dynamoelectric machine with an even number of phases; and a neutral point clamped (NPC) inverter system that receives electrical power from the positive and negative potential outputs the DC source to generate multiphase AC power for the dynamoelectric machine with the same number of even phases that exhibits no common mode potential/noise.

### DESCRIPTION OF THE DRAWINGS

FIG. 1 is a generalised schematic of one possible topology for a single-phase neutral-point clamped (NPC) inverter 2.

FIG. 2 is a generalised schematic for a four-phase NPC inverter that comprises four of the single-phase NPC inverters.

FIG. 3 is a schematic of a complete electromechanical power transfer system according to a possible embodiment of the invention in a starting or running mode.

FIG. 4 shows the electromechanical power transfer system of FIG. 3 in a generating mode.

### DETAILED DESCRIPTION OF THE INVENTION

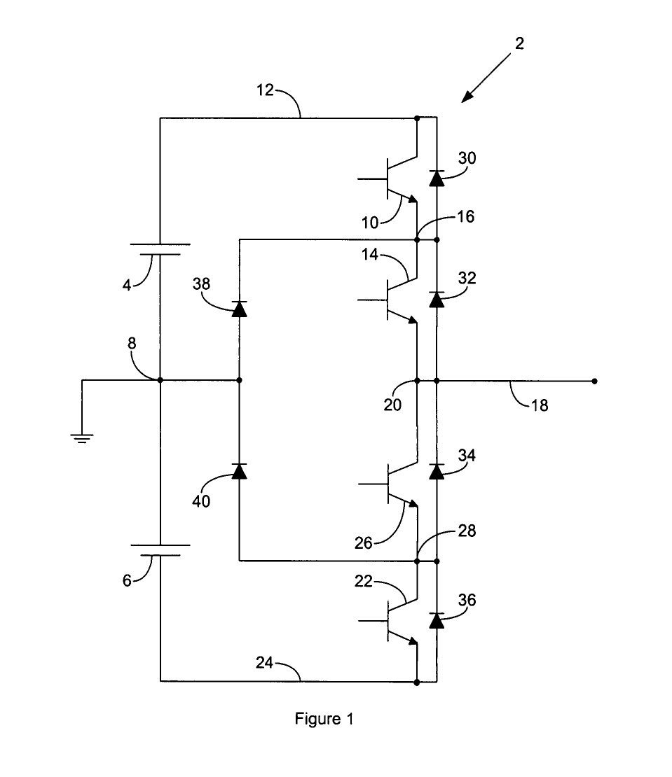

A neutral-point clamped (NPC) or three-level inverter does not suffer the same level of common mode voltage/noise as the three-leg six-switch inverter. This is because each phase clamps to neutral during the portion of each positive or negative switching cycle that the NPC turns off. FIG. 1 is a generalised schematic of one possible topology for a single-phase NPC inverter 2.

Positive DC source 4 and negative DC source 6 connect in series with a common mid-point connection point or node 8 to ground. The inverter 2 may have a plurality of switches, each switch comprising a controllable power-switching device such as a transistor, IGBT or MOSFET. One terminal of a positive pulse width modulating (PWM) switch 10 connects to the positive DC source 4 by way of a positive DC rail 12. The other terminal of the positive PWM switch 10 connects to one end of a top clamp switch 14 at a common connection point or node 16. The other terminal of the top clamp switch 14 connects to an AC phase output line 18 at an output connection point or node 20. Similarly, one terminal of a negative PWM switch 22 connects to the negative DC source 6 by way of a negative DC rail 24. The other terminal of the negative PWM switch 22 connects to one end of a bottom clamp switch 26 at a common connection point or node 28. The other terminal of the bottom clamp switch 26 connects to the AC phase output line 18 at the node 20.

Reverse or anti-parallel diodes 30, 32, 34 and 36 connect across the switches 10, 14, 22 and 26 to protect them from an inductive load connected to the AC phase output line 18 by providing a safe path for peak inductive load current as the switches 10, 14, 22 and 26 turn off. A first clamping diode 38 connected between node 8 and node 16 provides a current path for negative potential on the AC phase output line 18 to ground upon activating the top clamp switch 14. A second clamping diode 40 connected between node 8 and node 28 provides a current path for positive potential on the AC phase output line 18 to ground upon activating the bottom clamp switch 26.

The basic operation of the NPC inverter 2 is as follows. During a positive half of an AC cycle the top clamp switch 14 turns on and remains on for the duration of the positive half-cycle. The bottom clamp switch 26 turns on and remains on whilst the positive PWM switch 10 is off. This allows any positive potential on the AC phase output line 18 to discharge to ground by way of the second clamping diode 40, thereby grounding the AC phase output line 18 during the positive half of the AC cycle whilst the positive PWM switch 10 is off. Whenever the positive PWM switch 10 turns on, the bottom clamp switch 26 turns off to prevent the positive DC rail 12 from grounding out through the second clamping diode 40. The positive PWM switch 10 turns on and off during the positive half-cycle as necessary to let the positive DC source 4 supply positive potential current to the AC phase output line 18 by way of the positive DC rail 12 and the positive clamp switch 14 that approximates sine wave current across a load connected to the AC phase output line 18.

During a negative half of the AC cycle the bottom clamp switch 26 turns on and remains on for the duration of the negative half-cycle. The top clamp switch 14 turns on and remains on whilst the negative PWM switch 22 is off. This allows any negative potential on the AC phase output line 18 to discharge to ground by way of the first clamping diode 38, thereby grounding the AC phase output line 18 during the negative half of the AC cycle whilst the negative PWM 22 switch is off. Whenever the negative PWM switch 22 turns on, the top clamp switch 14 turns off to prevent the negative DC rail 24 from grounding out through the first clamping diode 38. The negative PWM switch 22 turns on and off during the negative half-cycle as necessary to let the negative DC source 6 supply negative potential current to the AC phase output line 18 by way of the negative DC rail 24 and the negative clamp switch 26 that approximates sine wave current across a load connected to the AC phase output line 18.

One advantage to the NPC inverter 2 is that its output on the AC phase output line 18 clamps to ground during the hereinbefore-described ground clamping intervals. That is, whereas a conventional two-level inverter phase leg would continually shift between the positive rail potential and the negative rail potential during each AC cycle to approximate a sine wave waveform across a load, the NPC inverter 2 shifts only between the positive rail potential and ground during the positive half of the AC cycle and between the negative rail potential during the negative half of the AC cycle. This feature reduces common mode potential/noise if multiple NPC inverters 2 combine to provide a multiphase AC output. In fact, if the number of phases is even, common mode potential/noise cancels out almost completely at any switching instance.

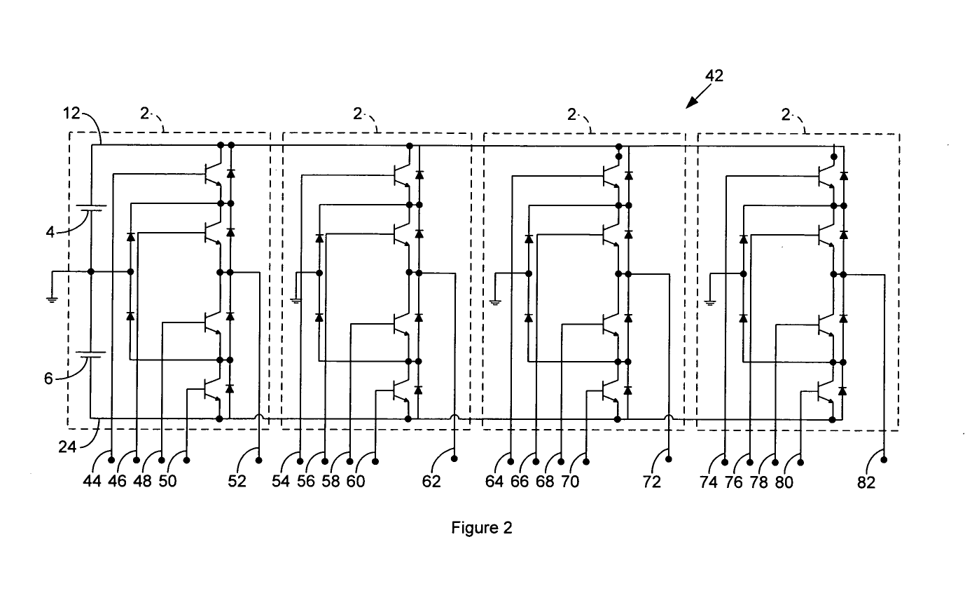

FIG. 2 is a generalised schematic for a four-phase NPC inverter 42 that comprises four of the single-phase NPC inverters 2. Line 44 receives a positive PWM gate drive signal to control the positive PWM switch 10 for Phase A. Line 46 receives a top clamp gate drive signal to control the top clamp switch 14 for Phase A. Line 48 receives a bottom clamp gate drive signal to control bottom clamp switch 26 for Phase A. Line 50 receives a negative PWM gate drive signal to control the negative PWM switch 22 for Phase A. Line 52 receives a Phase A output signal from the Phase A NPC inverter 2.

Line 54 receives a positive PWM gate drive signal to control the positive PWM switch 10 for Phase B. Line 56 receives a top clamp gate drive signal to control the top clamp switch 14 for Phase B. Line 58 receives a bottom clamp gate drive signal to control bottom clamp switch 26 for Phase B. Line 60 receives a negative PWM gate drive signal to control the negative PWM switch 22 for Phase B. Line 62 receives a Phase B output signal from the Phase B NPC inverter 2.

Line 64 receives a positive PWM gate drive signal to control the positive PWM switch 10 for Phase C. Line 66 receives a top clamp gate drive signal to control the top clamp switch 14 for Phase C. Line 68 receives a bottom clamp gate drive signal to control bottom clamp switch 26 for Phase C. Line 70 receives a negative PWM gate drive signal to control the negative PWM switch 22 for Phase C. Line 72 receives a Phase C output signal from the Phase C NPC inverter 2.

Line 74 receives a positive PWM gate drive signal to control the positive PWM switch 10 for Phase D. Line 76 receives a top clamp gate drive signal to control the top clamp switch 14 for Phase D. Line 78 receives a bottom clamp gate drive signal to control bottom clamp switch 26 for Phase D. Line 80 receives a negative PWM gate drive signal to control the negative PWM switch 22 for Phase D. Line 82 receives a Phase D output signal from the Phase D NPC inverter 2.

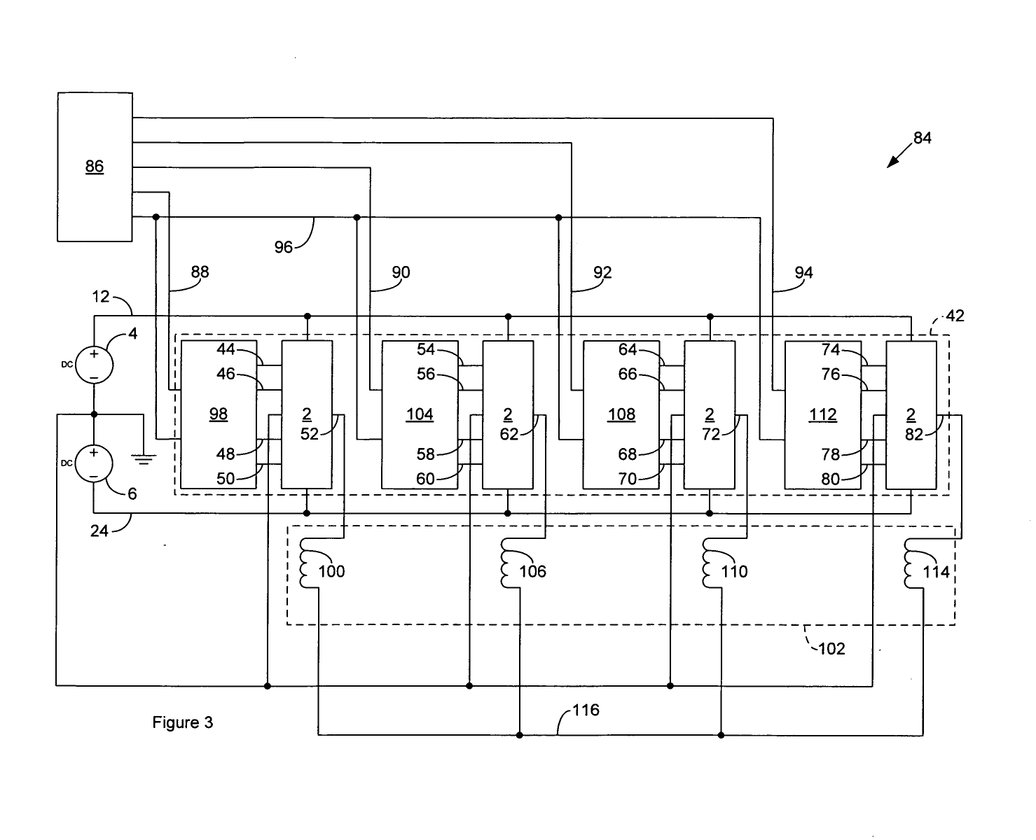

FIG. 3 is a schematic of a complete electromechanical power transfer system 84 according to a possible embodiment of the invention. The electromechanical power transfer system 84 comprises an even number of the single-phase NPC inverters 2. FIG. 3 shows the electromechanical power transfer system 84 comprising the four-phase NPC inverter 42 with four of the NPC inverters 2, although any even number of two or more of the single-phase NPC inverters 2 is satisfactory. A main controller 86 generates a Phase A reference signal on a Phase A reference signal line 88, a Phase B reference signal on a Phase B reference signal line 90, a Phase C reference signal on a Phase reference signal line 92, a Phase D reference signal on a Phase D reference signal line 94 and a triangular wave signal on a triangular wave signal line 96.

A Phase A NPC inverter controller 98 receives the Phase A reference signal on the Phase A reference signal line 88 and the triangular wave signal on the signal line 96 and generates the Phase A positive PWM gate drive signal on the line 44, the Phase A top clamp gate drive signal on the line 46, the Phase A bottom clamp gate drive signal on the line 48 and the Phase A negative PWM gate drive signal on the line 50. The Phase A NPC inverter 2 receives these signals to generate a corresponding Phase A output signal on the line 52. A Phase A stator winding 100 of a four phase dynamoelectric machine 102 receives the Phase A output signal on the line 52 and generates a respective Phase A magnetic field with flux that corresponds to current that passes through it to ground.

A Phase B NPC inverter controller 104 receives the Phase B reference signal on the Phase B reference signal line 90 and the triangular wave signal on the signal line 96 and generates the Phase B positive PWM gate drive signal on the line 54, the Phase B top clamp gate drive signal on the line 56, the Phase B bottom clamp gate drive signal on the line 58 and the Phase B negative PWM gate drive signal on the line 60. The Phase B NPC inverter 2 receives these signals to generate a corresponding Phase B output signal on the line 62. A Phase B stator winding 106 of the four phase PMM 102 receives the Phase B output signal on the line 62 and generates a respective Phase B magnetic field with flux that corresponds to current that passes through it to ground.

A Phase C NPC inverter controller 108 receives the Phase C reference signal on the Phase C reference signal line 92 and the triangular wave signal on the signal line 96 and generates the Phase C positive PWM gate drive signal on the line 64, the Phase C top clamp gate drive signal on the line 66, the Phase C bottom clamp gate drive signal on the line 68 and the Phase C negative PWM gate drive signal on the line 70. The Phase C NPC inverter 2 receives these signals to generate a corresponding Phase C output signal on the line 72. A Phase C stator winding 110 of the four phase PMM 102 receives the Phase C output signal on the line 72 and generates a respective Phase C magnetic field with flux that corresponds to current that passes through it to ground.

A Phase D NPC inverter controller 112 receives the Phase D reference signal on the Phase D reference signal line 94 and the triangular wave signal on the signal line 96 and generates the Phase D positive PWM gate drive signal on the line 74, the Phase D top clamp gate drive signal on the line 76, the Phase D bottom clamp gate drive signal on the line 78 and the Phase D negative PWM gate drive signal on the line 80. The Phase D NPC inverter 2 receives these signals to generate a corresponding Phase D output signal on the line 82. A Phase D stator winding 114 of the four-phase PMM 102 receives the Phase D output signal on the line 22 and generates a respective Phase D magnetic field with flux that corresponds to current that passes through it to ground.

The lack of common potential/noise property exhibited by the dynamoelectric machine controller system 84 is due to the combination of the NPC inverters 2 with the dynamoelectric machine 102 that has an even number of phases. Since the number of phases is even, at any switching instance, there are two of the switches 10, 14, 22 and 26 in two different phase legs switched at the same time, both of them to either the positive DC rail 12, the negative DC rail 24 or to ground. A central point of the four machine windings 116 therefore has an instant electrical potential positioned at the middle of the two outputs of each phase leg-pair. One is positive whilst the other is negative so that that the potential at the central point 116 is essentially zero at all times, and this is true for all leg-pairs simultaneously. The only additional filtering required with this topology is the for differential mode ripple, which still may flow out of the four phase NPC inverter 42 into the dynamoelectric machine 102. Using this kind of system should significantly enhance the life of bearings in the dynamoelectric machine and reduced filtering should reduce size and weight of any associated filtering system attached to the dynamoelectric machine 102.

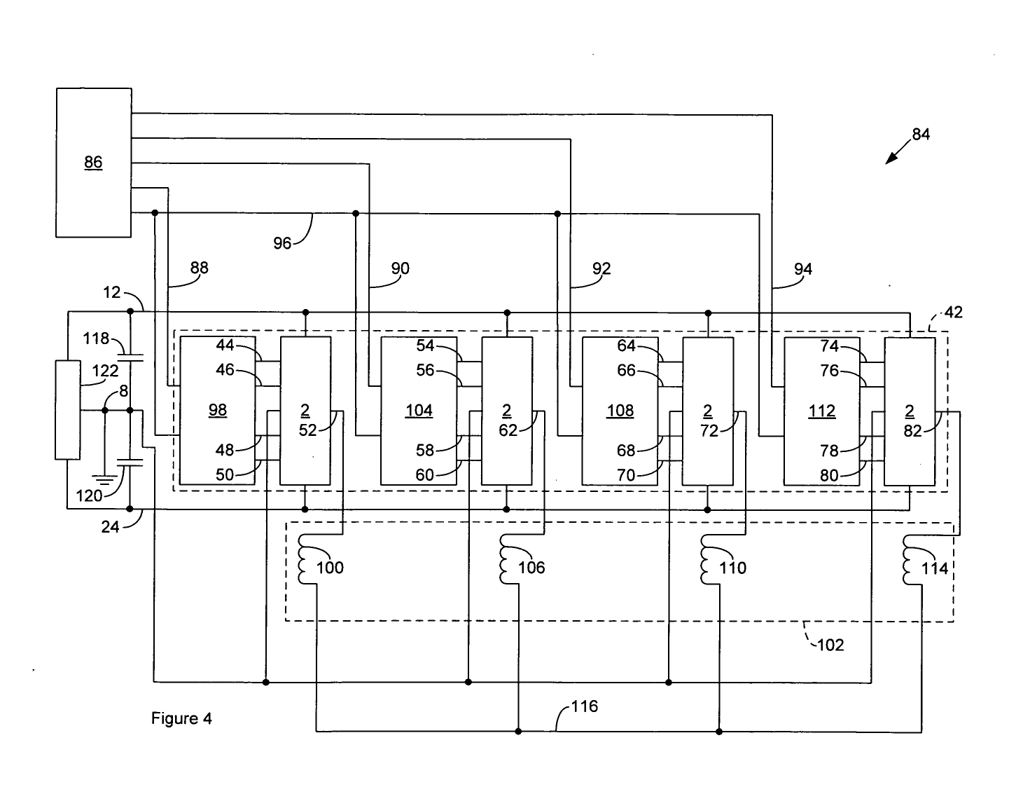

It is sometimes convenient for the dynamoelectric machine 102 to serve as both a source of variable mechanical power in a starting or running mode and as a source of multiphase AC power in a generating mode. For instance, in aeronautical applications the dynamoelectric machine 102 may start a prime mover, such as a gas turbine engine, that couples to the dynamoelectric machine 102 in its starting or running mode, and then after the prime mover achieves self-sustaining speed, the dynamoelectric machine 102 switches to a generating mode to generate multiphase AC power.

Whereas FIG. 3 as hereinbefore described shows the electromechanical power transfer system 84 in a starting or running mode, FIG. 4 shows the electromechanical power transfer system 84 in a generating mode. In this case, a prime mover (not shown) coupled to the dynamoelectric machine 102 serves as a source of variable mechanical power. The dynamoelectric machine 102 receives the variable mechanical power from the prime mover to generate multiphase AC power. The NPC inverter 42, under control of the main controller 86, switches from an inverter mode to an active rectifier mode to convert the multiphase AC power generated by the dynamoelectric machine 102 to DC power across the positive DC rail 12 and the negative DC rail 24.

A positive DC charging capacitor 118 and a negative DC charging capacitor 120 series connect across the positive DC rail 12 and the negative DC rail 24 with their common mid-point connection point or node 8 connected to ground. Likewise, an electrical load 122 may connect across the positive DC rail 12 and the negative DC rail 24 with a common ground connected to the node 8.

The described embodiments of the invention are only some illustrative implementations of the invention wherein changes and substitutions of the various parts and arrangement thereof are within the scope of the invention as set forth in the attached claims.

The claimed invention is:

1. An electromechanical power transfer system that converts direct current (DC) electrical power to variable mechanical power, comprising:
a source of DC that has a neutral ground, a positive potential output with a level of electrical potential that is positive relative to the neutral ground and a negative potential output with a level of electrical potential that is negative relative to the neutral ground;
a multiphase alternating current (AC) dynamoelectric machine with an even number of phases; and
a neutral point clamped (NPC) inverter system that receives electrical power from the positive and negative potential outputs the DC source to generate multiphase AC power for the dynamoelectric machine with the same number of even phases that exhibits no common mode potential/noise.

2. The electromechanical power transfer system of claim 1, wherein the NPC inverter system further comprises a single-phase NPC inverter for each of the NPC inverter system phases.

3. The electromechanical power transfer system of claim 2, wherein the NPC inverter system further comprises a NPC inverter controller for each NPC inverter.

4. The electromechanical power transfer system of claim 3, wherein the NPC inverter system further comprises a main controller that generates phase reference signals for each of the NPC inverter system phases.

5. The electromechanical power transfer system of claim 4, wherein each NPC inverter controller receives a respective one of the phase reference signals from the main controller to control its respective single-phase NPC inverter.

6. The electromechanical power transfer system of claim 5, wherein the main controller generates a triangular wave signal and each one of the inverter controllers receives the triangular wave signal to combine it with its respective phase reference signal for generating pulse width modulated (PWM) signals that control its respective single-phase NPC inverter.

7. The electromechanical power transfer system of claim 1, wherein the multiphase AC dynamoelectric machine and the NPC inverter system are four phase AC.

8. An electromechanical power transfer system that converts direct current (DC) electrical power to variable mechanical power, comprising:
a source of DC that has a neutral ground, a positive potential output with a level of electrical potential that is positive relative to the neutral ground and a negative potential output with a level of electrical potential that is negative relative to the neutral ground;
a multiphase alternating current (AC) dynamoelectric machine with an even number of phases;
a neutral point clamped (NPC) inverter for each phase of the dynamoelectric machine that receives electrical power from the positive and negative potential outputs the DC source;
a main controller that generates phase reference signals for each of the NPC inverter system phases and a triangular wave signal; and
a NPC inverter controller for each NPC inverter, wherein each NPC inverter controller receives a respective one of the phase reference signals and the triangular wave signal to generate multiphase AC power for the dynamoelectric machine with the same number of even phases that exhibits no common mode potential/noise.

9. The electromechanical transfer system of claim 8, wherein the multiphase AC dynamoelectric machine is four phase.

10. The electromechanical power transfer system of claim 1, wherein the dynamoelectric machine receives variable speed mechanical power to generate multiphase AC power in a generating mode and the NPC inverter system receives the multiphase AC power generated by the dynamoelectric machine and switches from an inverter mode to an active rectifier mode to convert the multiphase AC power to DC power for a DC load.

11. An electromechanical power transfer system that converts direct current (DC) electrical power to variable mechanical power in a running mode and converts variable mechanical power to DC electrical power in a generating mode, comprising:
a source of DC that has a neutral ground, a positive potential output with a level of electrical potential that is positive relative to the neutral ground and a negative potential output with a level of electrical potential that is negative relative to the neutral ground;
a multiphase alternating current (AC) dynamoelectric machine with an even number of phases that generates variable mechanical power when it receives multiphase AC power in a running mode and generates multiphase power when it receives variable mechanical power in a generating mode; and
a neutral point clamped (NPC) inverter system that receives electrical power from the positive and negative potential outputs the DC source in an inverter mode to generate multiphase AC power for the dynamoelectric machine with the same number of even phases that exhibits no common mode potential/noise and receives the multiphase AC power generated by the dynamoelectric machine in an active rectifier mode to convert the multiphase AC power to DC power for a DC load.

12. The electromechanical power transfer system of claim 11, wherein the NPC inverter system further comprises a single-phase NPC inverter for each of the NPC inverter system phases.

13. The electromechanical power transfer system of claim 12, wherein the NPC inverter system further comprises a NPC inverter controller for each NPC inverter.

14. The electromechanical power transfer system of claim 13, wherein the NPC inverter system further comprises a main controller that generates phase reference signals for each of the NPC inverter system phases.

15. The electromechanical power transfer system of claim 14, wherein each NPC inverter controller receives a respective one of the phase reference signals from the main controller to control its respective single-phase NPC inverter.

16. The electromechanical power transfer system of claim 15, wherein the main controller generates a triangular wave signal and each one of the inverter controllers receives the triangular wave signal to combine it with its respective phase reference signal for generating pulse width modulated (PWM) signals that control its respective single-phase NPC inverter.

17. The electromechanical power transfer system of claim 11, wherein the multiphase AC dynamoelectric machine and the NPC inverter system are four phase AC.

18. A method of converting direct current (DC) electrical power into variable mechanical power by means of a dynamoelectric machine, comprising the steps of:
generating a source of DC that has a neutral ground, a positive potential output with a level of electrical potential that is positive relative to the neutral ground and a negative potential output with a level of electrical potential that is negative relative to the neutral ground;
configuring a multiphase alternating current (AC) dynamoelectric machine to have an even number of phases; and
converting electrical power from the positive and negative potential outputs of the DC source to three-level pulse width modulated (PWM) multiphase AC power for the dynamoelectric machine with the same number of even phases that exhibits no common mode potential/noise.

19. The method of claim 18, wherein the multiphase AC is four phase.
